(19) United States
(12) Patent Application Publication
(10) Pub. No.: US 2016/0271765 A1
(43) Pub. Date: Sep. 22, 2016

(54) Wrench

(71) Applicant: Hsiu-Hua Chang, TAICHUNG (TW)

(72) Inventor: Hsiu-Hua Chang, TAICHUNG (TW)

(21) Appl. No.: 14/661,892

(22) Filed: Mar. 18, 2015

(51) Int. Cl. B25B 13/56; B25B 23/00; B25B 13/06

(52) U.S. Cl. CPC B25B 13/56; B25B 13/06; B25B 23/0035

(57) ABSTRACT

A wrench includes a handle and two sub-wrenches. The handle includes a shank and two pairs of prongs. Each pair of prongs is formed at a corresponding end of the shank. The prongs of each pair are separated from each other by a gap. Each of the sub-wrenches includes a lever and two pairs of sockets. The lever of each of the sub-wrenches is placed between and pivotally connected to a corresponding pair of prongs. Each of the sockets is transversely formed at a corresponding end of the lever and made with a hexagonal cavity of a unique size. Thus, the wrench is adapted for rotating nuts or threaded bolts of eight different sizes.

### BACKGROUND OF INVENTION

1. Field Of Invention

The present invention relates to a wrench and, more particularly, to a wrench equipped with various sockets.

2. Related Prior Art

A conventional wrench includes a shank and at least one boxed end or open end. Hence, wrenches of various sizes are needed to rotate nuts or threaded bolts of various sizes.

A socket wrench kit includes a handle and a set of sockets of various sizes. Thus, a socket wrench kit is adequate for rotating nuts or threaded bolts of various sizes. It however requires a box to store the handle and the set of sockets of various sizes.

Therefore, the present invention is intended to obviate or at least alleviate the problems encountered in prior art.

### SUMMARY OF INVENTION

It is the primary objective of the present invention to provide a wrench that is useful for rotating nuts or threaded bolts of various sizes.

To achieve the foregoing objective, the wrench includes a handle and two sub-wrenches. The handle includes a shank and two pairs of prongs. Each pair of prongs is formed at a corresponding end of the shank. The prongs of each pair are separated from each other by a gap. Each of the sub-wrenches includes a lever and two pair of sockets. The lever of each of the sub-wrenches is placed between and pivotally connected to a corresponding pair of prongs. Each of the sockets is transversely formed at a corresponding end of the lever and made with a hexagonal cavity of a unique size. Thus, the wrench is adapted for rotating nuts or threaded bolts of eight different sizes.

Other objectives, advantages and features of the present invention will be apparent from the following description referring to the attached drawings.

### BRIEF DESCRIPTION OF DRAWINGS

The present invention will be described via detailed illustration of four embodiments referring to the drawings wherein:

FIG. 1 is a perspective view of a wrench according to the first embodiment of the present invention;

FIG. 2 is an exploded view of the wrench shown in FIG. 1;

FIG. 3 is a cross-sectional view of the wrench shown in FIG. 1;

FIG. 4 is another cross-sectional view of the wrench shown in FIG. 1;

FIG. 5 is a partial, cross-sectional view of a wrench according to the second embodiment of the present invention;

FIG. 6 is a side view of a wrench according to the third embodiment of the present invention; and

FIG. 7 is a partial, cross-sectional view of a wrench according to the fourth embodiment of the present invention.

### DETAILED DESCRIPTION OF EMBODIMENTS

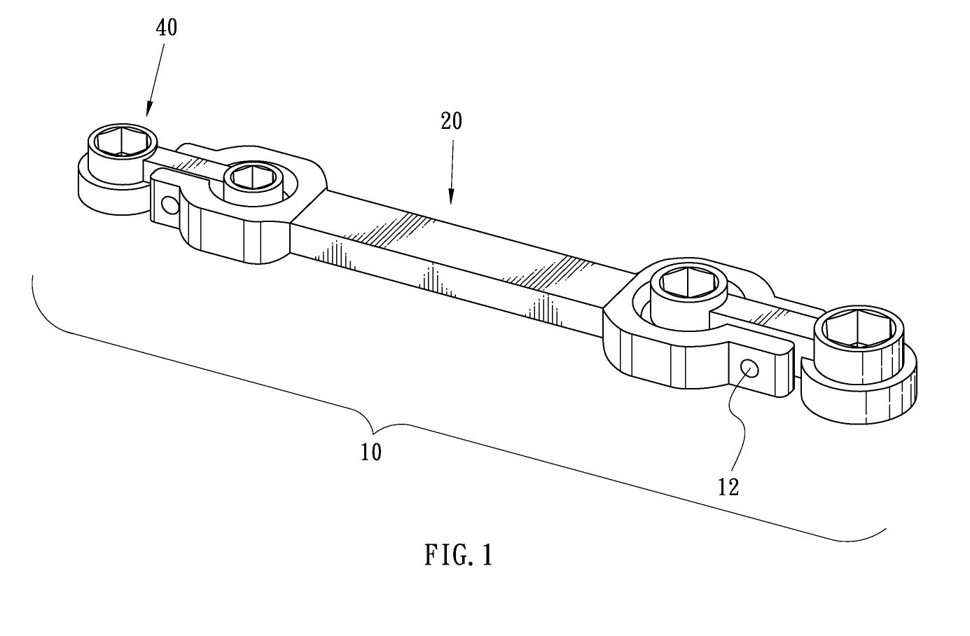

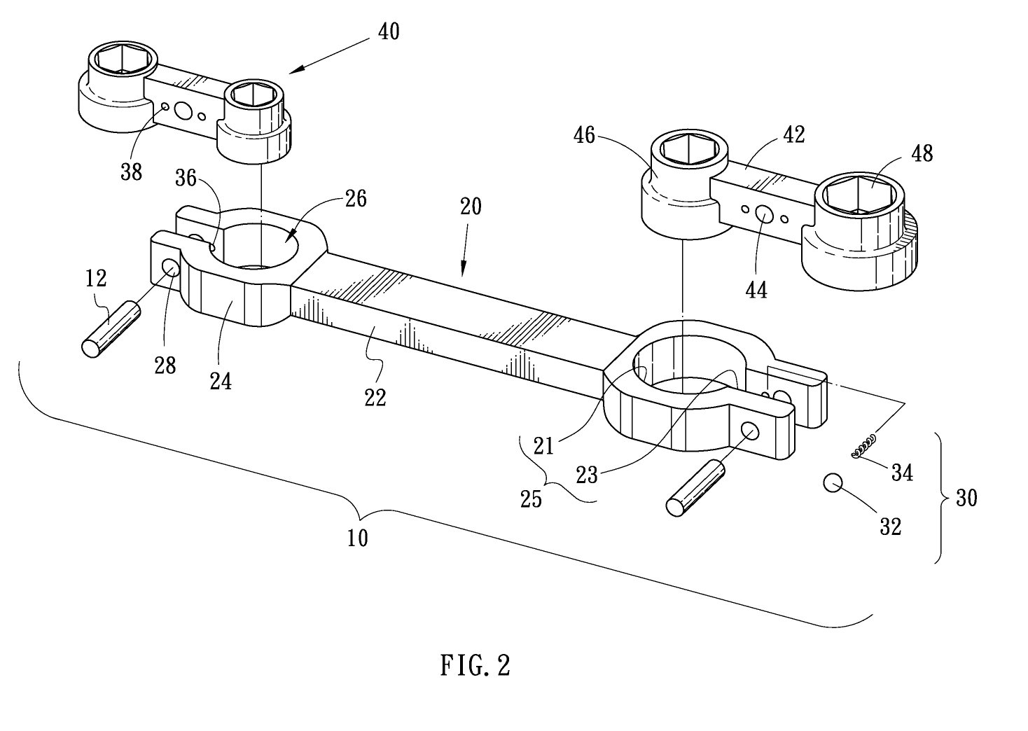

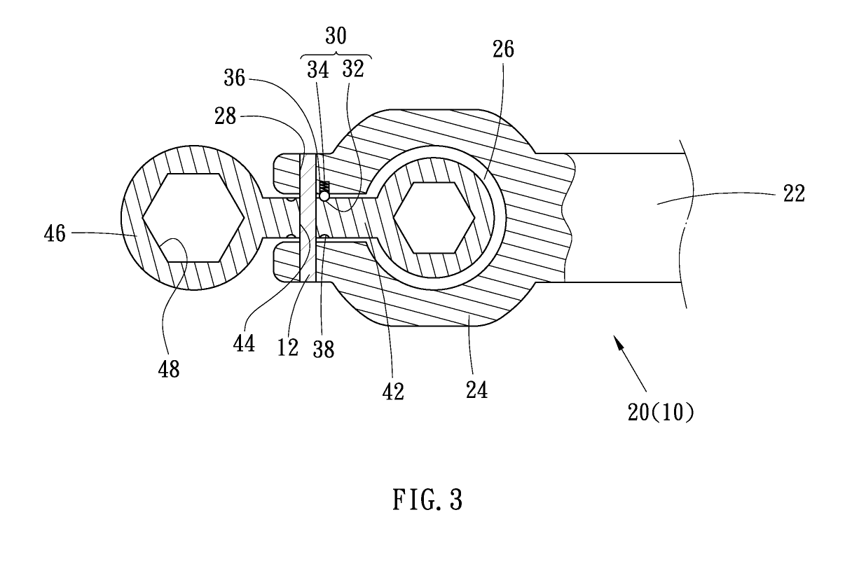

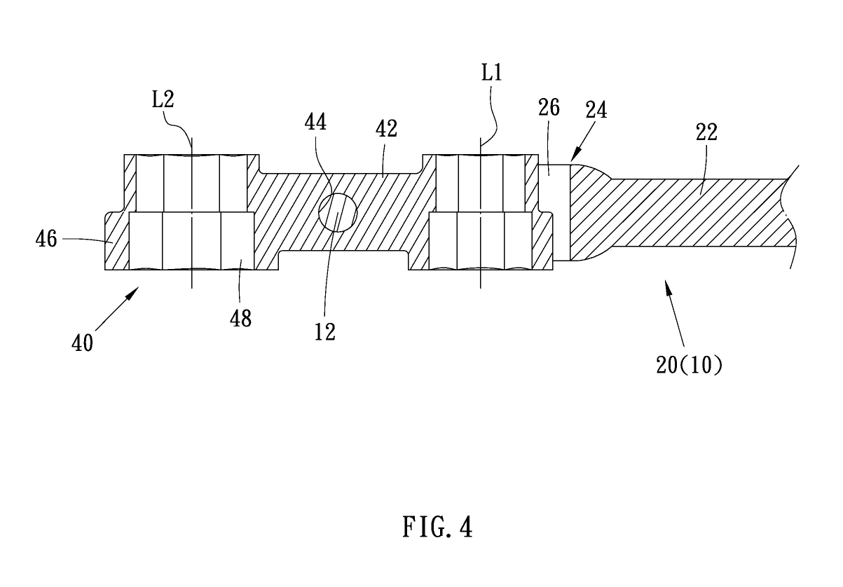

Referring to FIGS. 1 to 4, a wrench 10 includes a handle 20 and two sub-wrenches 40 in accordance with the first embodiment of the present invention. The handle 20 includes a shank 22 and two bifurcate ends (not numbered) each consisting of two prongs 24 separated from each other by a gap (not numbered). Each bifurcate end of the handle 20 includes a circular space 26 in communication with the gap between the prongs 24. The circular space 26 is defined by a concave face 21 that extends between the prongs 24 for almost 360°. Each prong 24 of each bifurcate end of the handle 20 includes a flat face 23 next to the concave face 21. The flat faces 23 of the prongs 24 of each bifurcate end of the handle 20 extend parallel to each other. Each prong 24 of each bifurcate end of the handle 20 includes an aperture 28 made therein.

Each sub-wrench 40 includes a lever 42 and two pairs of sockets 46. Each socket 46 is transversely formed at a corresponding end of the lever 42. The lever 42 includes an aperture 44 made therein. Each socket 46 includes a hexagonal cavity 48 of a unique size. In each pair of sockets 46, the hexagonal cavities 48 are in communication with each other along an axial direction. Thus, each sub-wrench 40 can be used to rotate nuts or threaded bolts of four different sizes. Hence, the wrench 10 can be used to rotate nuts or threaded bolts of eight different sizes. Each sub-wrench 40 is pivotally connected to a corresponding bifurcate end of the handle 20 by inserting a pin 12 in the aperture 44 made in the lever 42 thereof and the apertures 28 made in the prongs 24 of the corresponding bifurcate end of the handle 20.

Each sub-wrench 40 can be kept in position by a corresponding positioning unit 30. Each positioning unit 30 includes a detent 32, a spring 34, a bore 36 and two recesses 38. The detent 32 is in the form of a ball. The bore 36 is made in the flat face 23 of one of the prongs 24 of the corresponding bifurcate end of the handle 20. Both of the detent 32 and the spring 34 are inserted in the bore 36 so that the detent 32 is biased by the spring 34. The recesses 38 are made in a side of the lever 42 of the corresponding sub-wrench 40. The detent 32 of each positioning unit 30 can be inserted in one of the recesses 38 made in the lever 42 of the corresponding sub-wrench 40 to retain the corresponding sub-wrench 40 in one of two positions relative to corresponding bifurcate end of the handle 20.

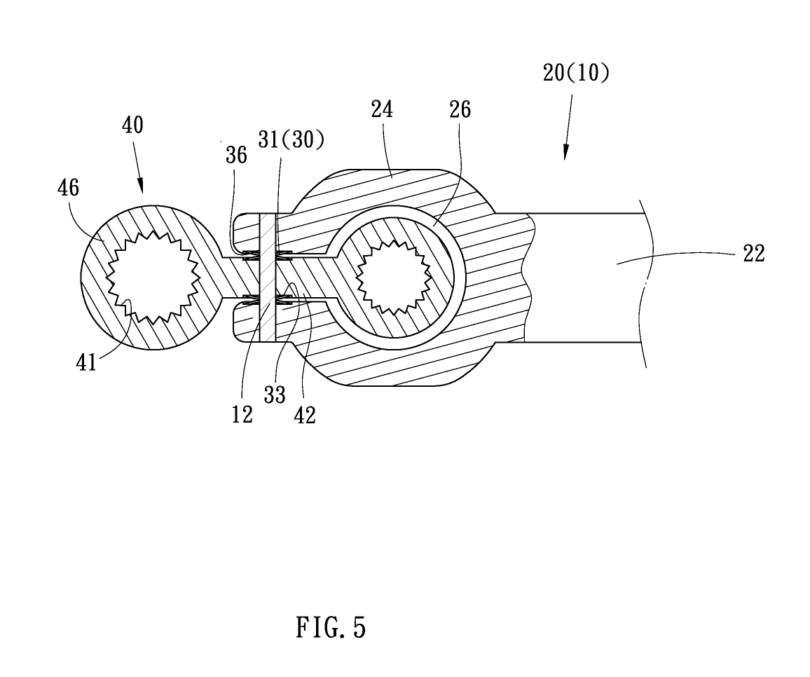

Referring to FIG. 5, a wrench according to a second embodiment of the present invention is shown. The second embodiment is identical to the first embodiment except several features. Firstly, each socket 46 includes a star-shaped cavity 41 instead of the hexagonal cavity 48. The star-shaped cavities 41 are made of different sizes. Secondly, each positioning unit 30 includes two pop washers 31 and at least one shallow cavity 33. The pop washers 31 are used instead of the combination of the detent 32 with the spring 34. The shallow cavity 33 is made in a side of the lever 42 of the corresponding sub-wrench 40 so that the shallow cavity 33 is in communication with the aperture 44. The shallow cavity 33 is made in one of the prongs 24 of each bifurcate end of the handle 20 so that the shallow cavity 33 is in communication with the aperture 28. One pop washer 31 is inserted in the shallow cavity 33 while the other pop washer 31 is inserted in the shallow cavity 33. The pop washers 31 of each positioning unit 30 are compressed against each other and between the lever 42 of the corresponding sub-wrench 40 and the corresponding prong 24 of the corresponding bifurcate end of the handle 20, thus retaining the corresponding sub-wrench 40 in position.

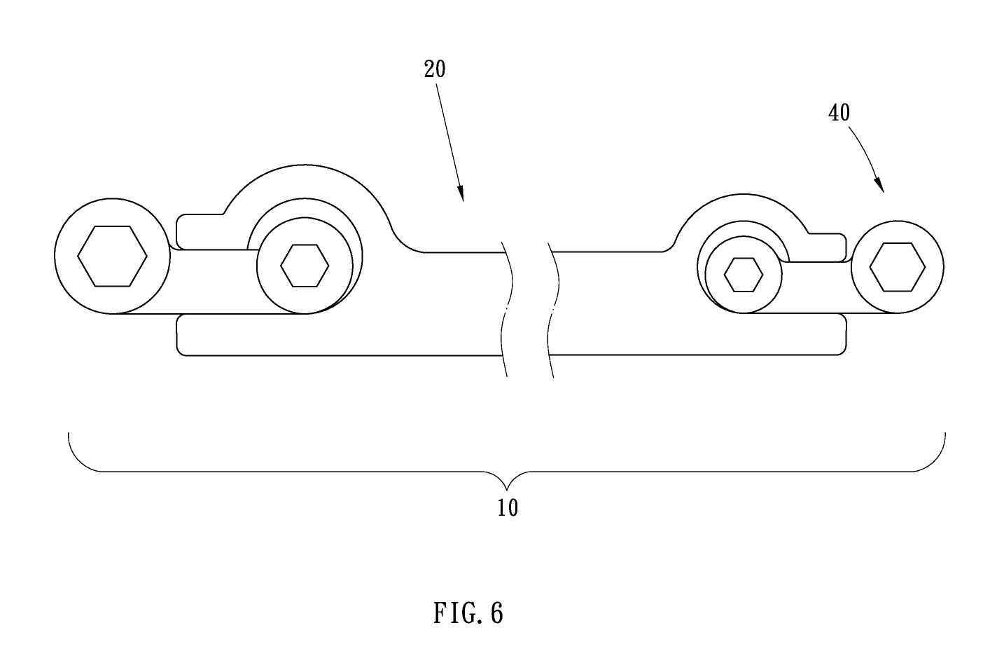

Referring to FIG. 6, a wrench according to a third embodiment of the present invention is shown. The third embodiment is identical to the first embodiment except that the sub-wrenches 40 are made in another shape and the bifurcate ends of the handle 20 are made in another shape.

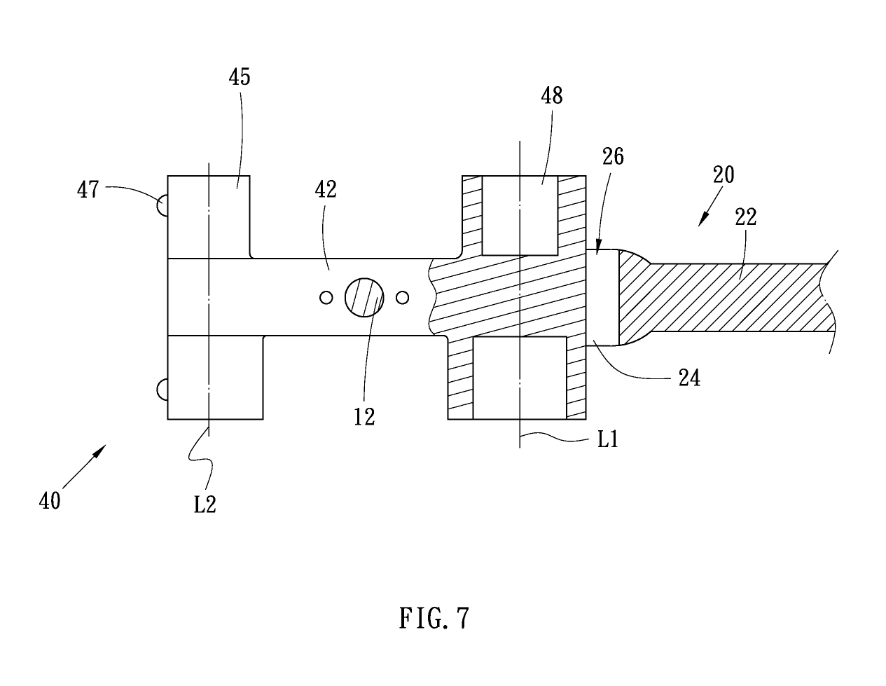

Referring to FIG. 7, a wrench according to a fourth embodiment of the present invention is shown. The fourth embodiment is like the first embodiment except several features. Firstly, each sub-wrench 40 includes two square rods 45 instead of two of the sockets 46. The transverse rods 45 are made of different sizes. A spring-biased detent 47 is placed on a side of each square rod 45. Each square rod 45 can be inserted in a square bore made in a socket (not shown) and retained there by the spring-biased detent 47. Secondly, the cavities 48 are square instead of hexagonal. Thirdly, the cavities 48 are not in communication with each other.

The present invention has been described via the detailed illustration of the illustrated embodiments. Those skilled in the art can derive variations from the illustrated embodiments without departing from the scope of the present invention. Therefore, the illustrated embodiments shall not limit the scope of the present invention defined in the claims.

1. A wrench including:
a handle including:
a shank; and
two pairs of prongs, wherein each pair of prongs is formed at a corresponding end of the shank, wherein the prongs of each pair are separated from each other by a gap;
two sub-wrenches each including:
a lever placed between and pivotally connected to a corresponding pair of prongs; and
two pair of sockets each transversely formed at a corresponding end of the lever, wherein each of the sockets includes a hexagonal cavity of a unique size so that the wrench is adapted for rotating nuts or threaded bolts of eight different sizes.

2. The wrench according to claim 1, the hexagonal cavities of the sockets of each pair are in communication with each other.

3. The wrench according to claim 1, the hexagonal cavities of the sockets of each pair are separated from each other.

4. The wrench according to claim 1, including two pins each inserted in the lever of a corresponding one of the sub-wrenches and a corresponding pair of prongs.

5. The wrench according to claim 4, wherein the lever of each of the sub-wrenches includes an aperture for receiving the pin, wherein each of the prongs includes an aperture for receiving the pin.

6. The wrench according to claim 1, wherein the handle including two circular spaces each in communication with the gap between the prongs of a corresponding pair.

7. The wrench according to claim 6, wherein the handle includes two concave faces each extends around a corresponding one of the circular spaces, wherein each of the concave faces extends for almost 360°.

8. The wrench according to claim 7, wherein each of the prongs includes a flat face next to the concave face so that the flat faces of the prongs of each pair extend parallel to each other.

9. The wrench according to claim 8, including two positioning units each arranged between the flat face of one of the prongs of a corresponding pair and a side of the lever of a corresponding one of the sub-wrenches for keeping a corresponding one of the sub-wrenches in position relative to the corresponding pair of prongs.

10. The wrench according to claim 9, wherein the lever of each of the sub-wrenches includes two recesses made in a side, wherein one of the prongs of each pair includes a bore 36 in the flat face, wherein each of the positioning units includes a detent and a spring inserted in the bore so that the detent is biased by the spring, wherein the detent of each of the positioning unit is adapted for insertion in one of the recesses made in the lever of the corresponding sub-wrench to retain the corresponding sub-wrench in one of two positions relative to the corresponding pair of prongs.

11. The wrench according to claim 10, wherein the detent is in the form of a ball.

12. The wrench according to claim 9, wherein each of the positioning units includes at least one spring compressed between the flat face of one of the prongs of a corresponding pair and a side of the lever of a corresponding one of the sub-wrenches.

13. A wrench including:
a handle including:
a shank; and
two pairs of prongs, wherein each pair of prongs is formed at a corresponding end of the shank, wherein the prongs of each pair are separated from each other by a gap;
two sub-wrenches each including:
a lever placed between and pivotally connected to a corresponding pair of prongs;
two sockets transversely formed at an end of the lever and each made with a hexagonal cavity of a unique sizes so that each of the sub-wrenches is adapted for rotating nuts or threaded bolts of four different sizes; and
two square rods transversely formed at another end of the lever and made of different sizes, wherein each of the square rods is adapted for insertion in a square bore made in a socket.

14. The wrench according to claim 9, including two spring-biased detents each placed on a corresponding one of the square rods.
